(19) United States
(12) Patent Application Publication
(10) Pub. No.: US 2003/0191649 A1
(43) Pub. Date: Oct. 9, 2003

(54) System and method for conducting transactions without human intervention using speech recognition technology

(76) Inventors: Trevor Stout, Los Altos, CA (US); Mark Wallin, San Jose, CA (US); Marius Seritan, San Jose, CA (US)

Correspondence Address: CARR & FERRELL LLP, 2225 EAST BAYSHORE ROAD, SUITE 200, PALO ALTO, CA, 94303, US

(21) Appl. No.: 10/408,018

(22) Filed: Apr. 3, 2003

Related U.S. Application Data
(60) Provisional application No. 60/369,841, filed on Apr. 3, 2002.

(51) Int. Cl. G10L 11/00

(52) U.S. Cl. 704/275

(57) ABSTRACT

A system and method are described for processing transaction instructions without human intervention. In one embodiment, a voice interpreter receives transaction information in the form of voice utterances, processes that information and transmits it to a business application server, which compiles the processed information and generates transaction instructions based on the compiled information. The business application server transmits the transaction instructions to an enterprise system via a connector manager that integrates the enterprise system with the business application server. At least one housing encloses the voice interpreter, the business application server and the hardware platform that supports the connector manager.

### BACKGROUND OF THE INVENTION

1. Field of the Invention

This invention relates generally to speech recognition technology and more particularly to a system and method for conducting transactions without human intervention using speech recognition technology to process customer transaction information.

2. Description of the Background Art

Many businesses or service providers (hereinafter “service providers”) have implemented telephone-based systems that allow customers to call those service providers to place orders for goods or services or to conduct other types of transactions. One shortcoming of these telephone-based systems is that human operators typically answer incoming customer calls and process customer transactions. Not only are these human operators sometimes not very well trained, they also frequently place customers on hold, especially during peak hours, to complete transactions from prior calls. The result is that customers often become frustrated when trying to conduct transactions over the phone, so they hang up in the middle of their transactions, thus terminating those transactions and causing the service providers to lose that business.

VoiceXML (Registered Trademark, owned by IEEE Industry Standards and Technology Organization, filed Aug. 9, 2000) is a language for creating voice-user interfaces, particularly for telephone-based systems. For example, VoiceXML has been used to create VoiceXML application-based systems such as voice portals and voice service providers. These types of systems allow service providers to provide automated, telephone-based information retrieval services and other transaction-based services to customers where the customers do not have to interact with human operators.

One drawback to implementing a VoiceXML application-based system is that the service provider has to design and build the system essentially from scratch (or pay a third party to design and build the system). In most instances, this means that the service provider has to design and build the VoiceXML application, design and configure the server on which the application will run and integrate the server with the service provider's existing enterprise systems. Further, the service provider has to design and build a voice browser to enable customers to access the VoiceXML application server and conduct transactions remotely over an appropriate communications medium such as a public switched telephone network. These technical hurdles are time consuming and prohibitively expensive for many service providers.

### SUMMARY OF THE INVENTION

One embodiment of a system for processing transaction instructions without human intervention includes a voice interpreter for receiving transaction information, in the form of voice utterances or DTMF commands, and for processing that transaction information, a business application server for receiving the processed transaction information and for generating transaction instructions, a connector manager for interfacing with an enterprise system and for transmitting the transaction instructions to the enterprise system and at least one housing designed to enclose the voice interpreter, the business application server and the connector manager. The embodiment also includes a telephony interface that allows a customer to access the system using any type of communications medium, including without limitation, a public switched telephone system, a private telephone network, a voice-over-IP packet network or any type of wireless network.

One advantage of this system is that it constitutes a “turn-key” automated transaction system. A service provider may implement the system by simply “plugging” the service provider's enterprise system(s) into the connector manager and the communications medium used to access the system into the telephony interface. By using this system, the service provider avoids having to design and build an automated transaction system from scratch, meaning that the service provider does not have to design and build a business application server that is integrated with the service provider's enterprise system(s) or design and build voice browsing functionality that enables customers to access the business application server and remotely conduct a transaction over an appropriate communications medium. The system therefore is a straightforward and cost-effective way for a service provider to implement an automated transaction system.

### BRIEF DESCRIPTION OF THE DRAWINGS

FIG. 1 is a block diagram illustrating one embodiment of a system used to conduct a transaction without human intervention, according to the invention;

FIG. 2 is a block diagram illustrating one embodiment of the voice appliance of FIG. 1, according to the invention;

FIG. 3 is a block diagram illustrating one embodiment of the business application server of FIG. 1, according to the invention;

FIG. 4 is a block diagram illustrating one embodiment of the connector manager of FIG. 2, according to the invention; and

FIG. 5 shows a flow chart of method steps for conducting a transaction without human intervention, according to one embodiment of the invention.

### DETAILED DESCRIPTION OF THE INVENTION

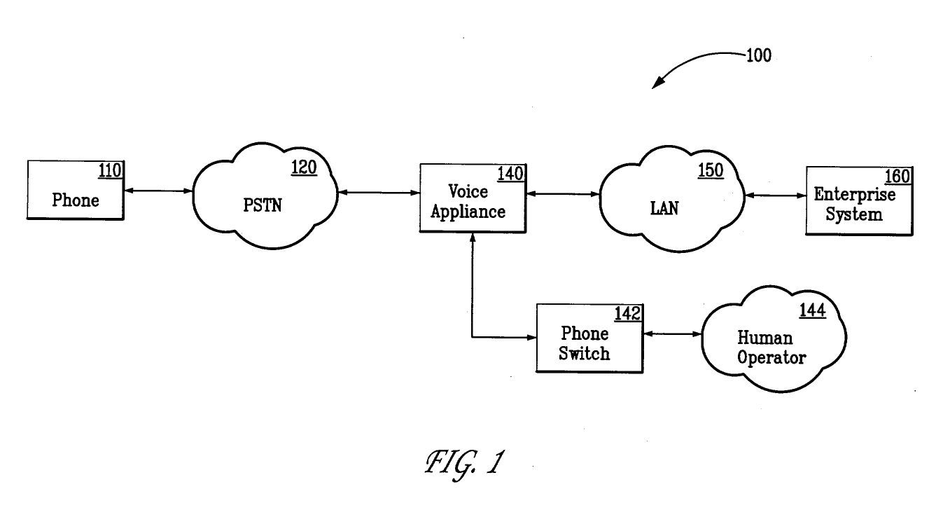

FIG. 1 is a block diagram illustrating one embodiment of a system 100 used to conduct a transaction without human intervention, according to the invention. Typical transactions may include, for example, purchasing a product or a service. As shown, system 100 may include, without limitation, a phone 110, a public switched telephone network (PSTN) 120, a voice appliance 140, an analog phone switch 142, a human operator 144, local area network (LAN) 150 and an enterprise system 160. Using phone 110, a customer calls a service provider with whom the customer wants to conduct the transaction, and the call is routed through PSTN 120 to voice appliance 140.

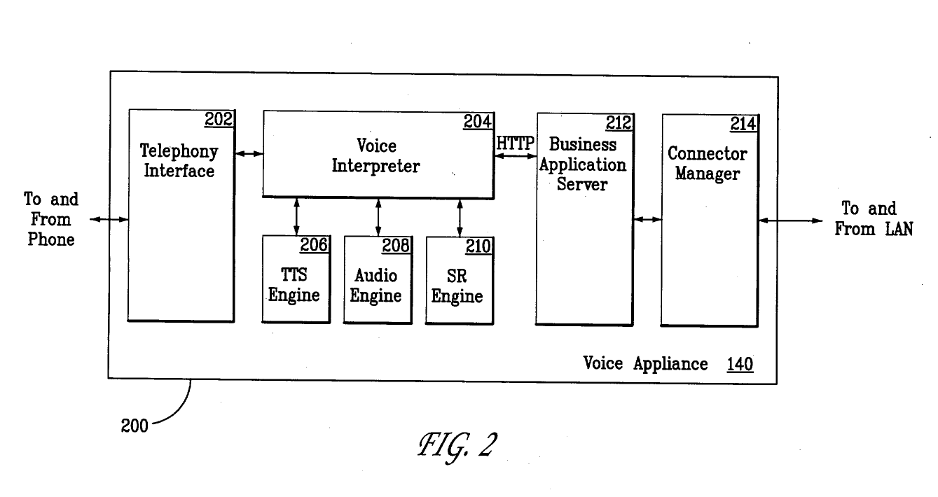

As described herein, once the customer is in communication with voice appliance 140, the customer and voice appliance 140 participate in a “dialog,” during which the customer transmits all information relevant to the transaction (the “transaction information”) to voice appliance 140. The transaction information may be in the form of voice utterances spoken into phone 110 and, optionally, dual-tone multi-frequency (DTMF) commands entered into phone 110. As explained in further detail below in conjunction with FIG. 2, voice appliance 140 is configured to participate in the dialog with the customer, to process the transaction information provided by the customer, to generate transaction instructions based on the transaction information and to submit the transaction instructions to enterprise system 160. Voice appliance 140 typically may reside on the premises of the service provider.

Voice appliance 140 is coupled to enterprise system 160 via an enterprise network, such as LAN 150, which may be any type of packet-based network (e.g., TCP/IP, IPX/SPX or NetBEUI) over which data (e.g., the transaction instructions described herein) is transmitted between voice appliance 140 and enterprise system 160 using HTTP or other similar transport protocols. Alternatively, voice appliance 140 may be coupled directly to enterprise system 160 using any type of serial ports such as USB or RS-232 ports or parallel ports.

One feature of voice appliance 140 is that the customer can opt to by-pass the automated transaction process and to have his or her call routed directly to human operator 144 so that human operator 144 may process the customer's transaction. Under such circumstances, voice appliance 140 is configured to route the customer's call to human operator 144 via analog phone switch 142, which is coupled to voice appliance 140. Those skilled in the art will recognize that analog phone switch 142 may be any type of analog or digital device that couples voice appliance 140 to human operator 144.

Enterprise system 160 is configured to receive the transaction instructions submitted by voice appliance 140 and to process those transaction instructions. Enterprise system 160 may be any type of transaction-based system used by the service provider. For example, if the service provider is a restaurant such as a pizza delivery restaurant, fast food restaurant or some type of dining-in restaurant, enterprise system 160 may be a point-of-sale system, a reservation system or customer relationship management (CRM) system. If the service provider is a financial institution, enterprise system 160 may be a CRM system or a financial/accounting system such as Oracle Financials or Siebel Finance. Those ordinarily skilled in the art will recognize that a given service provider may have more than one enterprise system 160 and that voice appliance 140 may be adapted to couple to multiple enterprise systems simultaneously.

Those ordinarily skilled in the art also will recognize that PSTN 120 may be any type of telephone network, including but not limited to, a private telephone network such as PBX, a voice-over-IP packet network, any type of wireless network or any other suitable communications medium. Further, phone 110 may be any type of telephony device that couples to the telephone network used in system 100.

In alternative embodiments, an analog phone switch or any other similar analog or digital device may couple PSTN 120 to voice appliance 140. In addition, phone 110 and PSTN 120 may be replaced with any type of non-telephony; microphone-based device that can be coupled to voice appliance 140 and configured to transmit voice utterances and, optionally, DTMF commands to voice appliance 140. An example of such a microphone-based device is a speaker/microphone device of the sort typically found at fast-food restaurant drive-through.

FIG. 2 is a block diagram illustrating one embodiment of voice appliance 140 of FIG. 1, according to the invention. As shown, voice appliance 140 may include, without limitation, a housing 200, a telephony interface 202, a voice interpreter 204, a text-to-speech (TTS) engine 206, an audio engine 208, a speech recognition (SR) engine 210, a business application server 212 and a connector manager 214. Housing 200 can be made of any type of suitable material such as plastic, metal or hard rubber. In one embodiment, housing 200 is sized to enclose telephone interface 202, voice interpreter 204, TTS engine 206, audio engine 208, SR engine 210, business application server 212 and connector manager 214. In alternative embodiments, two or more separate and/or related housings may enclose any number of these various components.

Telephony interface 202 integrates voice interpreter 204 with PSTN 120 of FIG. 1. More specifically, telephony interface 202 is configured to answer an incoming call from the customer, to initiate a session with voice interpreter 204 and to manage the communication protocols between PSTN 120 and voice appliance 140. Further, telephony interface 202 is configured to receive requests for customer transaction information (in the form of audio output) from voice interpreter 204, to transmit those requests to the customer via PSTN 120, to receive customer transaction information (in the form of audio input and DTMF commands) from PSTN 120 and to transmit that information to voice interpreter 204 for processing. The functionality of telephony interface 202 may be implemented in hardware and/or software. Intel's Dialogic card is an example of a commonly used telephony interface product.

Voice interpreter 204 is configured to control the dialog between the customer and voice appliance 140 by processing voice-adapted programmable code (“voice script”) that resides in business application server 212. The voice script may be based on any language used to create voice-user interfaces, such as VoiceXML. As explained in greater detail herein, the voice script sets forth the “flow” of the dialog between the customer and voice appliance 140. The flow delineates the types of information needed from the customer to process the customer's transaction as well as the order in which that information should be solicited from the customer. More specifically, voice interpreter 204 is configured to request and receive the voice script from business application server 212, to parse through and execute the instructions in the voice script, to generate requests for customer transaction information (in the form of audio output), to transmit those requests to telephony interface 202, to process incoming customer transaction information (in the form of audio input or DTMF commands) received from telephony interface 202 in the form of audio input and to transmit the processed transaction information to business application server 212. Voice interpreter 204 may be any VoiceXML interpreter or any other similar device.

When telephony interface 202 answers the incoming call from the customer and initiates a session with voice interpreter 204, voice interpreter 204 requests the first portion of the voice script that resides in business application server 212. Business application server 212 is configured to receive this request from voice interpreter 204 and to transmit the first portion of the voice script to voice interpreter 204 for processing. Voice interpreter 204 then parses through and executes the instructions in that first portion of voice script. For example, if the voice script indicates that voice appliance 140 should request certain transaction information from the customer, such as a selection from a group of choices or specific input relevant to the transaction at hand, voice interpreter 204 transmits that request to audio engine 208 for processing. Audio engine 208 may be any automated library of pre-recorded audio files and is configured to receive the transaction information request, to locate the pre-recorded audio file that matches the request and to transmit the contents of that audio file to voice interpreter 204. In turn, voice interpreter 204 transmits as audio output the contents of the file to telephony interface 202 (where the contents are then transmitted or played to the customer via phone 110 and PSTN 120). In the event that audio engine 208 cannot locate an audio file that matches the transaction information request, voice interpreter 204 may instead transmit the transaction information request to TTS engine 206 for processing. TTS engine 206 may be any standard speech synthesis engine and is configured to receive the transaction information request, to generate synthetic speech that matches the request and to transmit the synthetic speech to voice interpreter 204. In turn, voice interpreter 204 transmits as audio output the synthetic speech to telephony interface 202 (where the synthetic speech is then transmitted or played to the customer via phone 110 and PSTN 120).

Similarly, if the voice script indicates that the customer should transmit transaction information to voice appliance 140, voice interpreter 204 directs the incoming transaction information that is in the form of audio input to SR engine 210 for processing. SR engine 210 may be any standard automated speech recognition engine and is configured to receive the audio input and to process the audio input by, among other things, interpreting the audio input and generating a data stream or equivalent set of information that matches the audio input. SR engine 210 is further configured to transmit the processed transaction information to voice interpreter 204, which, in turn, transmits that information to business application server 212. In the situation where the incoming transaction information is in the form of DTMF commands, voice interpreter 204 directs that transaction information to business application server 212 without first diverting the information to SR engine 210 for processing.

Voice interpreter 204 also is configured to analyze the flow set forth in the voice script and to determine whether additional dialog with the customer is necessary based on factors such as whether additional transaction information is needed from the customer to process the customer's transaction. If voice interpreter 204 determines that additional transaction information is needed, voice interpreter 204 requests from business application server 212 the next portion of the voice script as set forth in the flow. Business application server 212 is configured to receive this request from voice interpreter 204 and to transmit the next portion of the voice script to voice interpreter 204 for processing. Voice interpreter 204 receives this next portion of the voice script and parses through and executes the instructions contained in that portion of script. As previously described herein, the result of this process is that voice appliance 140 requests and receives additional transaction information from the customer. Again, voice interpreter 204 processes this transaction information and transmits it to business application server 212. This process repeats until voice interpreter 204 determines that no further transaction information is needed from the customer to process the customer's transaction. All communications between voice interpreter 204 and business application server 212 take place using HTTP or other similar transport protocols.

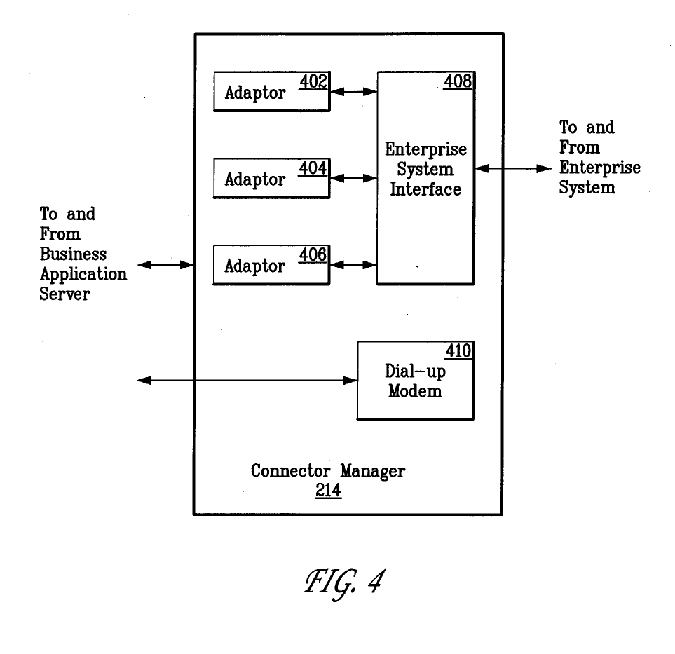

As previously described herein, business application server 212 is configured to receive requests for portions of the voice script from voice interpreter 204, to process those requests and transmit the requested portions of the voice script to voice interpreter 204 for processing and to receive the processed transaction information transmitted by voice interpreter 204. Business application server 212 is further configured to compile this processed transaction information, to generate transaction instructions upon receiving all of the necessary transaction information from the customer and to transmit the transaction instructions to connector manager 214. The transaction instructions may be implemented using XML or any other similar language or any type of object-based communications. As discussed in greater detail below in conjunction with FIG. 4, connector manager 214 is configured to receive the transaction instructions from business application server 212, to translate those instructions into a format understood by enterprise system 160 and to transmit those instructions, via LAN 150 or directly, to enterprise system 160 for processing.

The form of the transaction instructions will vary according to the types of transactions that system 100 is designed to process. As those skilled in the art will recognize, the instructions contained in the voice script and the transaction-specific functionality of enterprise system 160 are two, but not necessarily the only, factors that define the form of the transaction instructions. For example, if the voice script sets forth a process for ordering a pizza, and enterprise system 160 is a point-of-sale system, then the transaction instructions may be an order for a particular type of pizza that the customer wants to eat for dinner. Similarly, if the voice script sets forth a process for setting up a 401(k) account, and enterprise system 160 is a system for storing and managing those accounts, then the transaction instructions may designate a new mutual fund that the customer wants to add to his or her 401(k) account or a new allocation of funds among the mutual funds in the customer's 401(k) account.

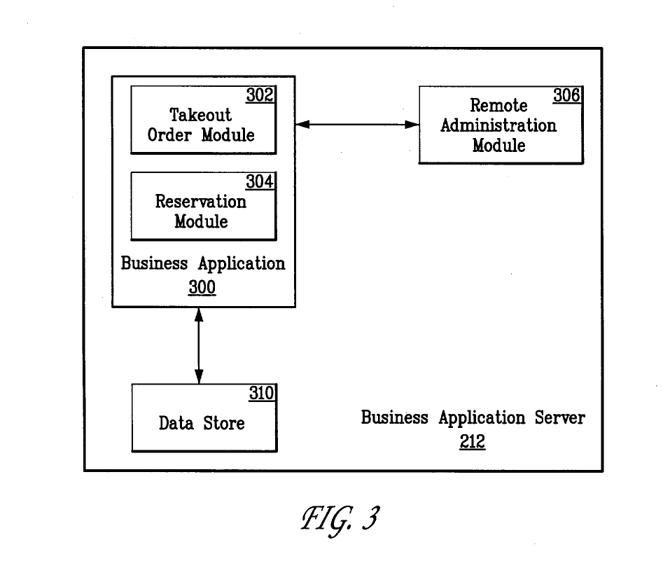

FIG. 3 is a block diagram illustrating one embodiment of business application server 212 of FIG. 1, according to the invention. As shown, business application server 212 may include, without limitation, a business application 300, a remote administration module 306, an appliance/module administration module 308 and a data store 310. Business application server 212 may be any web server or similar computing device that is accessible using HTTP or any other similar protocols.

Among other things, business application 300 contains the voice script previously described herein. In one embodiment, business application 300 is an order-based application (i.e., a set of program instructions) that pizza delivery, take-out and dining-in restaurants, for example, may use. As also shown in FIG. 3, the order-based application includes, without limitation, takeout order module 302 and reservation module 304. Take out order module 302 is configured to take a food order from a customer and, among other things, contains the portions of the voice script that set forth the flow for taking such food orders. The portions of the voice script contained in take out module 302 therefore delineate the types of information needed from the customer and the order in which that information should be solicited/requested from the customer to generate that customer's food order. For example, in the pizza delivery context, the voice script may set forth a series of questions asked to the customer to determine, among other things, the type of crust and the various toppings that the customer wants for his or her pizza. The voice script also may include questions pertaining to how the customer wants to pay for the pizza (e.g., credit card, debit card or cash) as well as delivery instructions and/or directions. In addition, the voice script may include instructions for transmitting certain information to the customer relevant to the customer's order, such as the cost of certain toppings or of different sizes of pizza, different order options that the customer may have as well as estimated delivery time.

Take out order module 302 may include various functionalities that enhance the overall effectiveness of the order-based application. For example, take out module 302 may include specific program instructions that provide for a caller identification functionality that identifies a repeat customer based on that customer's voice, phone number, DTMF commands or some other similar type of input. Take out module 302 also may include specific program instructions that provide for a repeat-order functionality that allows an identified repeat customer to circumvent the regular order-taking process and simply reorder one of the items ordered by that customer in one or more past transactions. Similarly, take out module 302 may include specific program instructions that provide for a functionality that confirms customer-based information such as delivery address and credit card information for identified repeat customers. Other functionalities that take out order module 302 may have include, without limitation, a suggestive selling functionality (where information regarding various types of promotions is communicated to customers), a special offer functionality (where customers are advised of additional items that they can purchase that will qualify those customers for various special offers or promotions) and a loyalty tracking functionality (where a point system or similar system is used to track customer order histories so that customers can qualify for special benefits).

Reservation module 304 is configured to take a reservation request from a customer and, among other things, contains the portions of the voice script that set forth the flow for taking such reservation requests. The portions of voice script contained in reservation module 304 therefore delineate the types of information needed from a customer and the order in which that information should be solicited/requested from the customer to generate that customer's reservation request. For example, in the dining-in restaurant context, the voice script may set forth a series of questions asked to the customer to determine, among other things, the time at which the customer would like to dine, the number of persons in the customer's party and the customer's table location preference. The voice script also may include informational transmissions to the customer that confirm the reservation time and the number of person in the customer's party.

Data store 310 is configured to store persistent data necessary to execute the voice script contained in business application 300. Data store 310 may contain one or more databases, XML files or any other persistent data structures or storage mechanisms used to store data. For example, in the situation where business application 300 is an order-based application, data store 310 may contain, without limitation, the menus that a particular restaurant offers, the restaurant's pricing rules, information relating to the past orders of customers and statistics based on those past orders or past customers. Similarly, in the situation where business application 300 is a 401(k) account management application, data store 310 may contain, without limitation, listings of the various mutual funds in the 401(k) program, the fee structures of those mutual funds, information relating to past account choices made by program participants and statistics based on those past choices or past participants.

Those skilled in the art will recognize that in alternative embodiments business application 300 may be configured to access some or all of the data necessary to execute portions of the voice script from enterprise system 160 instead of or in addition to data store 310. For example, in the situation where business application 300 is an order-based application and enterprise system 160 is a point-of-sales system, enterprise system 160 may store customer information such as credit card information, delivery address information or demographic information about the service provider's historic customer base. Enterprise system 160 also may store, without limitation, information relating to the past orders of customers, product information, the menus that a particular service provider offers as well as the pricing rules relating to the different products that the service provider offers.

Remote administration module 306 is configured to enable the remote administration of the different components of voice appliance 140 such as, for example, business application 300 and its relevant modules and connector manager 214. Remote administration module 306 is further configured to manage connectivity to voice appliance 140 by a remote dial-in connection, by a scheduled, automatic dial-out connection or through a LAN-based connection. Once connected, a system administrator may service, manage or configure the different components of voice appliance 140 via remote administration module 306 using either terminal-based commands, a web-based interface such as a browser, or available software applications such as Microsoft's NetMeeting.

FIG. 4 is a block diagram illustrating one embodiment of connector manager 214 of FIG. 2, according to the invention. As shown, connector manager 214 may include, without limitation, one or more adaptors, such as adaptor 402, adaptor 404 and adaptor 406, enterprise system interface 408 and dial-up modem 410. Generally, connector manager 214 is configured to translate information received from business application server 212 into a format that can be understood by enterprise system 160 and to translate information received from enterprise system 160 into a format that can by understood by business application server 212. The translation functionality of connector manager 214 enables business application server 212 and enterprise system 160 to communicate with one another. More specifically, adaptors such as adaptor 402, adaptor 404 and adaptor 406 provide connector manager 214 with this translation functionality. For example, each of adaptor 402, adaptor 404 and adaptor 406 may be configured to interface with a unique type of commercial enterprise system such that each of adaptor 402, adaptor 404 and adaptor 406, as the case may be, is able to translate information received from business application server 212 into a format understood by a particular type of enterprise system as well as receive translate information received from that particular type of enterprise system into a format understood by business application server 212. Examples of various types of adaptors include, but are not limited to, an adaptor configured to interface with a database enterprise system such as the Oracle 11i CRM system, an adaptor configured to interface with a point-of-sale enterprise system such as the Breakaway Relief Manager Plus system, an adaptor configured to interface with an enterprise system that supports EDI, an adaptor configured to interface with a printer and an adaptor configured to interface with a facsimile machine or any other similar type of device.

In one embodiment, the total number of adaptors 402, 404 and 406 included in connector manager 214 is equal to the number of enterprise systems 160 in system 100 (i.e., system 100 has three enterprise systems 160, each of which interfaces uniquely with one of adaptor 402, adaptor 404 and adaptor 406). Among other things, such an arrangement allows voice appliance 140 to be a “turn-key” device because the service provider can simply “plug” voice appliance into its existing enterprise system infrastructure by coupling each of adaptor 402, adaptor 404 and adaptor 406 to the enterprise system 160 with which adaptor 402, adaptor 404 or adaptor 406 has been uniquely configured to interface.

Connector manager 214 is further configured to manage the flow of information between business application server 212 and enterprise system 160 by (i) receiving information from business application server 212, directing that information through the appropriate adaptor(s), such as adaptor 402, adaptor 404 and/or adaptor 406, and transmitting that information via enterprise system interface 408 to enterprise system 160 and (ii) receiving information from enterprise system 160 via enterprise system interface 408, directing that information through the appropriate adaptor(s), such as adaptor 402, adaptor 404 and/or adaptor 406, and transmitting that information to business application server 212. In addition, connector manager 214 is configured to manage the protocol(s) used to transmit information from enterprise system 160. For example, connector manager 214 may transmit transaction instructions to enterprise system 160 using HTTP if those instructions are implemented using XML, or connector manager 214 may use SQL to transmit information to enterprise system 160 if enterprise system 160 is a database system. Other protocols that connector manager 214 may use include TCP/IP or any other suitable protocol or language. The functionality of connector manager 214 and adaptor 402, adaptor 404 and adaptor 406 (as well as any other adaptors) may be implemented in hardware and/or software.

Enterprise system interface 408 is configured to couple connector manager 214 to LAN 150, where voice appliance 140 is coupled to enterprise system 160 indirectly via LAN 150, or to couple connector manager 214 to enterprise system 160, where voice appliance 140 is coupled to enterprise system 160 directly. In the former situation, enterprise system interface 408 may be any type of appropriate network interface card such as an OC-3 SONET connection or an Ethernet over fiber connection. In the latter situation, enterprise interface 408 may be any type of serial port such as a USB or RS-232 port or any type of parallel port.

Dial-up modem 410 is the device through which remote dial-in connections and automatic, dial-out connections occur for purposes of remotely administering voice appliance 140 as previously described herein. Dial-up modem 410 may be any type of modem or similar communication device. Those skilled in the art will recognize that in alternative embodiments, dial-up modem 410 may reside outside of connector manager 214 and be located anywhere within or external to voice appliance 140. Further, dial-up modem 410 can be substituted with any other suitable communications interface known in the art to effectuate remote administration.

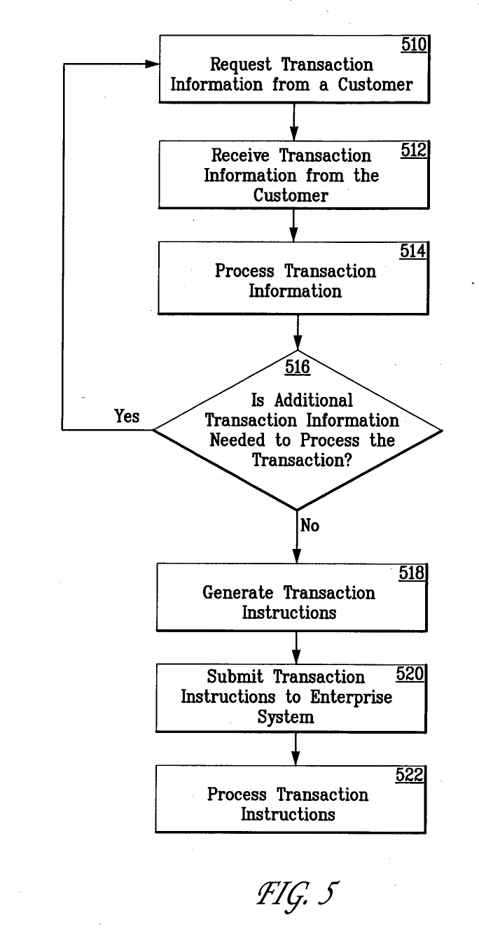

FIG. 5 shows a flowchart of method steps for conducting a transaction without human intervention, according to one embodiment of the invention. Although the method steps are described in the context of the systems illustrated in FIGS. 1-4, any system configured to perform the methods steps is within the scope of the invention.

As shown in FIG. 5, the method for conducting a transaction without human intervention starts in step 510 where voice appliance 140 requests transaction information from a customer. As described herein, in one embodiment, the customer accesses voice appliance 140 by calling via phone 110 the service provider with whom the customer wants to conduct the transaction. Once in communication with voice appliance 140, voice interpreter 204 requests from business application server 212 the first portion of the voice script contained in business application 300, which resides in business application server 212. Voice interpreter 204 parses through and executes the instructions in this first portion of voice script. These instructions include requesting certain transaction information from the customer. The requests for transaction information are played/transmitted from voice interpreter 204 to the customer using audio engine 208 and/or TTS engine 206.

In step 512, voice appliance 140 receives the transaction information requested from the customer. The transaction information may be in the form of voice utterances spoken into phone 110 and, optionally, DTMF commands entered into phone 110. In step 514, voice interpreter 204 processes the received transaction information using SR engine 210, to the extent that the transaction information is in the form of voice utterances, and transmits the processed transaction information to business application server 212. In step 516, voice interpreter 204 analyzes the flow set forth in the voice script and determines whether any addition transaction information is needed from the customer to process the customer's transaction.

If voice interpreter 204 determines that additional transaction information is needed from the customer, voice interpreter 204 requests the next portion of the voice script, which contains instructions for requesting additional transaction information from the customer, from business application server 212 and the method returns to step 510. If voice interpreter 204 determines that no further transaction information is needed from the customer, then in step 518, business application server 212 compiles the processed transaction information received from voice interpreter 204 and generates transaction instructions. In step 520, business application server 212 via connector manager 214 transmits or submits the transaction instructions to enterprise system 160 for processing. In step 522, enterprise system 160 processes the transaction instructions.

One advantage of the system (and associated methods) described above is that it constitutes a “turn-key” automated transaction system. A service provider may implement the functionality of voice appliance 140 by simply “plugging” the service provider's enterprise system(s) 160 into connector manager 214 and the communications medium used to access voice appliance 140 into telephony interface 202. By using voice appliance 140, the service provider avoids having to design and build an automated transaction system from scratch, meaning that the service provider does not have to design and build business application server 212 that is integrated with the service provider's enterprise system(s) 160 or design and build voice browsing functionality that enables customers to access business application server 212 and remotely conduct a transaction over an appropriate communications medium. The system therefore is a straightforward and cost-effective way for a service provider to implement an automated transaction system.

The invention has been described above with reference to specific embodiments. One skilled in the art will recognize, however, that various modifications and changes may be made thereto without departing from the broader spirit and scope of the invention as set forth in the appended claims. For example, telephony interface 202, voice interpreter 204 (as well as TTS engine 206, audio engine 208 and SR engine 210), business application server 212 and connector manager 214 may run on a common processor or hardware platform. Alternatively, voice appliance 140 may be designed such that one or more of these components may run on one or more separate processors or hardware platforms. Also, one or more business applications 300 may reside in business application server 212. This capability allows a service provider to use one voice appliance 140 to conduct different types of transactions simultaneously or in series without having to introduce additional business applications servers 212 into voice appliance 140 or having to use more than one voice appliance 140 in system 100. In addition, voice appliance 140 may be implemented using a distributed architecture. For example, suppose a service provider has three locations at which the service provider wants to set up automated transactions systems 100. One could design voice appliance 140 such that a separate set of telephony interface 202 and voice interpreter 202 (along with TTS engine 206, audio engine 208 and SR engine 210) resides at each of the three locations, and each set of telephony interface 202 and voice interpreter 204 communicates to one centrally located business application server 212 and connector manager 214. The foregoing description and drawings are, accordingly, to be regarded in an illustrative rather than a restrictive sense.

What is claimed is:

1. A system for processing transaction instructions without human intervention, comprising:
a voice interpreter configured to process transaction information received in the form of voice utterances;
a business application server configured to compile the processed transaction information and to generate transaction instructions;
a hardware platform that supports a connector manager configured to integrate the business application server with an enterprise system and to transmit the transaction instructions to the enterprise system; and
at least one housing configured to enclose the voice interpreter, the business application server and the hardware platform that supports the connector manager.

2. The system of claim 1, wherein the business application server includes a business application that contains a voice script.

3. The system of claim 2, wherein the business application is an order-based application that includes a module configured to take an order from a customer.

4. The system of claim 3, wherein the order-based application includes a module configured to detect the identity of a caller.

5. The system of claim 3, wherein the order-based application includes a module configured to enable the customer to reorder one or more items ordered in a previous transaction.

6. The system of claim 3, wherein the order-based application includes a module configured to communicate one or more promotions to the customer.

7. The system of claim 3, wherein the order-based application includes a module configured to advise the customer of one or more additional items that the customer may purchase to qualify for a special offer or a promotion.

8. The system of claim 3, wherein the order-based application includes a module configured to use an order history to qualify the customer for certain rewards or special benefits.

9. The system of claim 3, wherein the order-based application includes a module configured to take reservation requests.

10. The system of claim 1, further comprising a telephony interface configured to receive the voice utterances and to transmit them to the voice interpreter for processing.

11. The system of claim 1, wherein the connector manager a first adaptor configured to communicate with a first enterprise system and a second adaptor configured to communicate with a second enterprise system.

12. A method for processing transaction instructions without human intervention, comprising:
requesting transaction information from a customer based on instructions set forth in a first portion of voice script;
receiving the requested transaction information from the customer in the form of voice utterances;
processing the received transaction information using a speech recognition engine;
determining whether additional transaction information is needed from the customer and, if so, requesting a next portion of voice script and requesting additional transaction information from the customer based on instructions set forth in the next portion of voice script;
compiling the processed transaction information;
generating transaction instructions based on the compiled processed transaction information;
translating the transaction instructions into a format understood by an enterprise system; and
submitting the transaction instructions to the enterprise system for processing.

13. The method of claim 12, further comprising the step of processing the transaction instructions.

14. The method of claim 12, wherein the steps of requesting transaction information and requesting additional transaction information include taking an order from the customer based on one or more instructions set forth in the voice script.

15. The method of claim 12, wherein the steps of requesting transaction information and requesting additional transaction information include detecting the identity of a caller based on one or more instructions set forth in the voice script.

16. The method of claim 12, wherein the steps of requesting transaction information and requesting additional transaction information include enabling the customer to reorder one or more items ordered in a previous transaction based on one or more instructions set forth in the voice script.

17. The method of claim 12, wherein the steps of requesting transaction information and requesting additional transaction information include communicating one or more promotions to the customer based on one or more instructions set forth in the voice script.

18. The method of claim 12, wherein the steps of requesting transaction information and requesting additional transaction information include advising the customer of one or more additional items that the customer may purchase to qualify for a special offer or a promotion based on one or more instructions set forth in the voice script.

19. The method of claim 12, wherein the steps of requesting transaction information and requesting additional transaction information include using an order history to qualify the customer for certain rewards or special benefits based on one or more instructions set forth in the voice script.

20. The method of claim 17, wherein the steps of requesting transaction information and requesting additional transaction information include taking a reservation request from the customer based on one or more instructions set forth in the voice script.

21. A system for processing transaction instructions without human intervention, comprising:
a means for requesting transaction information from a customer based on instructions set forth in a first portion of voice script;
a means for receiving the requested transaction information from the customer in the form of voice utterances;
a means for processing the transaction information;
a means for determining whether additional transaction information is needed from the customer and, if so, requesting a next portion of voice script and requesting additional transaction information from the customer based on instructions set forth in the next portion of voice script;
a means for compiling the processed transaction information;
a means for generating transaction instructions based on the compiled processed transaction information;
a means for translating the transaction instructions into a format understood by an enterprise system; and
a means for submitting the transaction instructions to the enterprise system for processing.

22. The system of claim 21, further comprising means for processing the transaction instructions.

23. The system of claim 21, wherein the means for requesting transaction information and requesting additional transaction information include a means for taking an order from the customer based on one or more instructions set forth in the voice script.

24. The system of claim 21, wherein the means for requesting transaction information and requesting additional transaction information include a means for detecting the identity of a caller based on one or more instructions set forth in the voice script.

25. The system of claim 21, wherein the means for requesting transaction information and requesting additional transaction information include a means for enabling the customer to reorder one or more items ordered in a previous transaction based on one or more instructions set forth in the voice script.

26. The system of claim 21, wherein the means for requesting transaction information and requesting additional transaction information include a means for communicating one or more promotions to the customer based on one or more instructions set forth in the voice script.

27. The system of claim 21, wherein the means for requesting transaction information and requesting additional transaction information include a means for advising the customer of one or more additional items that the customer may purchase to qualify for a special offer or a promotion based on one or more instructions set forth in the voice script.

28. The system of claim 21, wherein the means for requesting transaction information and requesting additional transaction information include a means for using an order history to qualify the customer for certain rewards or special benefits based on one or more instructions set forth in the voice script.

29. The system of claim 21, wherein the means for requesting transaction information and requesting additional transaction information include a means for taking a reservation request from the customer based on one or more instructions set forth in the voice script.
